(19) United States
(12) Patent Application Publication
(10) Pub. No.: US 2025/0001879 A1
(43) Pub. Date: Jan. 2, 2025

(54) VEHICLE

(71) Applicant: NCR Corporation, Atlanta, GA (US)

(72) Inventors: Stephen William Swaine, Dunkeld (GB); Andrew William Douglas Smith, Dundee (GB); Liam Fraser Mccafferty, Dundee (GB); Steven James Birnie, Dundee (GB); Marshall Munro, Dunfermline (GB)

(21) Appl. No.: 18/216,732

(22) Filed: Jun. 30, 2023

(51) Int. Cl. B60L 50/60; G07F 19/00

(52) U.S. Cl. CPC B60L 50/60; G07F 19/20; B60L 2200/36

(57) ABSTRACT

A vehicle comprises a vehicle body comprising a first end, a further end, opposite the first end, and at least one side extending between the first end and the further end, wherein the vehicle body comprises: at least one Automated Teller Machine, ATM, wherein at least one respective fascia of the at least one ATM forms part of an outer surface of the vehicle body; and at least one battery configured to provide power at least to the at least one ATM.

### FIELD OF THE INVENTION

The present invention relates to a vehicle including an Automated Teller Machine (ATM). In particular, but not exclusively, the present invention relates to an electric vehicle with a vehicle body defining an outer surface that is at least partly formed by a fascia of an ATM, enabling user access of the ATM in any environment.

### BACKGROUND

Automated Teller Machines (ATMs) are known. An automated teller machine (ATM) is an electronic banking outlet that allows customers/users to complete basic transactions without the aid of a bank representative or teller. Anyone with a credit card or debit card can access transaction services at most ATMs. ATMs provide both basic cash-dispensing services as well as advanced functions, including: check depositing, account information access, fund transfers, marketing of relevant products and the like. Historically, ATMs have not included any functionality to enable a user to communicate with a remote bank teller. However, newer types of ATM do have additional functionality that enables a user to communicate with a bank teller. These new types of ATMs are sometimes referred to as Interactive Teller Machines (ITMs). ITMs offer the basic components of an ATM, such as the receipt printer and card reader; however, ITMs usually include additional features such as: a video camera and handset for conducting conversations with a teller, a coin dispenser for distributing different denominations of coins, an ID scanner for authenticating the customer, a signature pad and the like.

Typically, ATMs and ITMs are installed in physical bank branches. However, continuing physical bank branch closures has resulted in increased unavailability of local banking services via ATMs or ITMs. These closures are increasing due to the availability of online banking services, digitisation of cash, and the high cost of investment for building, maintaining, and running a bank branch. However, despite the reasons for branch closures there are many communities and population segments that require cash, prefer cash, and who don't have access or cannot access online banking. These people are being poorly served by banks and, within the UK, Europe and the USA, legislation is being introduced to ensure that society has access to cash and banking services.

To solve this problem, existing branch-on-wheels trucks have been used. However, these trucks are huge, polluting, noisy and expensive and are not suitable to enable all members of a population to access them. Accessibility to the banking services for customers is hindered due to the size of the vehicles which require steps or ramps. It is also difficult to provide these trucks at certain locations where a remote bank branch may be required.

### SUMMARY

It is an aim of the present invention to at least partly mitigate one or more of the above-mentioned problems.

It is an aim of certain embodiments of the present invention to help provide an electric vehicle with an ATM.

It is an aim of certain embodiments of the present invention to help provide a vehicle of certain dimensions which enables the vehicle to travel through doors and thus enabling an ATM integrated into the vehicle to be suitably located at any location, indoors or outdoors.

It is an aim of certain embodiments of the present invention to help provide a vehicle with an ATM that can be accessed without having to ascend a ramp or steps, thus allowing access to all users including those in wheelchairs.

It is an aim of certain embodiments of the present invention to help provide a vehicle including an ATM with little to no carbon footprint (e.g., zero emissions).

It is an aim of certain embodiments of the present invention to service a vehicle including an ATM at a central hub to reduce the number of service engineer visits and cash in transit events and thereby further reduce carbon footprint.

According to a first aspect of the present invention there is provided a vehicle for transporting at least one Automated Teller Machine, ATM, from a first location to a second location, the vehicle comprising: a vehicle body comprising a first end, a further end, opposite the first end, and at least one side extending between the first end and the further end, wherein the vehicle body comprises: at least one Automated Teller Machine, ATM, wherein at least one respective fascia of the at least one ATM forms part of an outer surface of the vehicle body; and at least one battery configured to provide power at least to the at least one ATM.

Aptly, a difference between a depth and/or a width of the or each ATM and a width of the vehicle body is no more than 0.5 meters, and optionally no more than 0.1 meters.

Aptly, the width of the vehicle body is less than 1 meter, and is optionally between 0.8 meters and 0.95 meters.

Aptly, a height of the vehicle body is less than 2.5 meters, and is optionally between 2.0 and 2.1 meters.

Aptly, a minimum height of a display and/or an encrypted PIN pad and/or a card reader and/or a cash dispenser of the ATM is no more than 1.2 meters from a base of the vehicle body.

Aptly, the fascia of at least one said ATM forms part of the outer surface on the side of the vehicle body.

Aptly, the fascia of at least one said ATM forms part of the outer surface on the further end of the vehicle body.

Aptly, the vehicle further comprises: at least one door, hingeably connected to the vehicle body, locatable in a first position and a second position; wherein in the first position, the door covers the ATM and wherein in the second position, the door exposes the ATM to enable a user to access the ATM.

Aptly, the vehicle further comprises: at least one solar panel, on a roof and/or the side and/or the first end and/or the further end of the vehicle body, electrically connected to the battery for proving power to the battery.

Aptly, a floor of the vehicle body supports the ATM.

Aptly, the vehicle is an electric vehicle comprising the vehicle body.

Aptly, the electric vehicle further comprises: a plurality of wheels, supporting the vehicle body, for moving the vehicle body across a surface; and at least one electric motor for providing a driving force to the wheels, wherein said battery provides power to the electric motor.

Aptly, the vehicle further comprises: a driver cabin, at the first end of the vehicle body, comprising a steering wheel, an accelerator control and a brake control.

Aptly, the first end of the vehicle body comprises a transparent windscreen.

Aptly, the plurality of wheels comprises a first set of wheels, arranged beneath the first end of the vehicle body and a second set of wheels, arranged beneath the further end of the vehicle body.

Aptly, each of the plurality of wheels is independently steerable.

Aptly, the vehicle is a trailer connected or connectable to an electric vehicle.

Aptly, the trailer further comprises: a plurality of wheels, supporting the vehicle body at the first end, for moving the vehicle body across a surface; and at least one stabiliser, supporting the vehicle body at the further end.

According to a second aspect of the present invention there is provided a method for servicing an ATM, comprising the steps of: driving a vehicle comprising at least one Automated Teller Machine, ATM, wherein at least one respective fascia of the at least one ATM forms part of an outer surface of a body of the vehicle, into a building or to a position adjacent an opening in an outer wall of the building; opening an access door on the vehicle, that allows an operator to access a rear portion of the ATM, into an interior of the building; and servicing the ATM.

According to a third aspect of the present invention there is provided an electric vehicle comprising at least one Automated Teller Machine, ATM.

Certain embodiments of the present invention help provide a vehicle including an ATM.

Certain embodiments of the present invention help provide one or more of the following advantages:

Accessibility: Mobile bank branches according to certain embodiments of the present invention can reach customers in areas where traditional brick-and-mortar branches are not available or feasible to establish. This ensures that banking services are accessible to a wider population, including those in rural, isolated regions or high traffic areas such as shopping malls. Certain embodiments of the present invention also have a much lower floor pan over conventional mobile branches which eliminates the need for steps/stairs, meaning it can be wheelchair accessible.

Convenience: The mobile bank branch according to certain embodiments of the present invention brings banking services directly to customers' locations, saving them time and effort in traveling to a physical branch. This convenience is particularly beneficial for individuals with limited mobility or busy schedules.

Cost-effective: Compared to establishing and maintaining traditional bank branches, mobile bank branches according to certain embodiments of the present invention offer a cost-effective solution. They help eliminate the need for constructing and operating permanent structures, reducing overhead costs associated with rent, utilities, and staffing.

Flexibility: Mobile bank branches according to certain embodiments of the present invention can adapt to changing customer needs and market demands. They can be relocated to different locations based on demand patterns or events, ensuring that banking services are readily available wherever they are required.

Outreach and Financial Inclusion: Mobile bank branches can play a significant role in promoting financial inclusion by extending banking services to unbanked or underbanked populations. Certain embodiments of the present invention, by providing access to basic banking services, such as account opening, cash withdrawals, and deposits, contribute to economic empowerment and financial literacy in underserved communities.

Customer Engagement: Mobile bank branches can offer opportunities for personalized customer interactions and relationship building. Bank representatives can engage with customers on a one-on-one basis, providing financial advice, assistance, and addressing their specific needs. Via this personalized touch, certain embodiments of the present invention enhances customer satisfaction and loyalty.

Technology Integration: Mobile bank branches can leverage technology to enhance service delivery. They can incorporate digital banking capabilities, such as mobile banking apps, card issuance, biometric identification, and remote banking services. These technological integrations in certain embodiments of the present invention streamline processes, reduce paperwork, and enhance the overall customer experience.

Disaster Recovery: Mobile bank branches can play a crucial role in disaster-stricken areas by quickly restoring banking services. Certain embodiments of the present invention can be deployed to areas affected by natural disasters, enabling access to financial resources, and assisting in relief efforts.

### BRIEF DESCRIPTION OF THE DRAWINGS

Embodiments of the present invention will now be described hereinafter, by way of example only, with reference to the accompanying drawings in which:

FIG. 1 illustrates a side view of an electric vehicle including an ATM;

FIG. 2 illustrates a side view of a further electric vehicle including an ATM;

FIG. 3 illustrates a side view of a trailer including an ATM;

FIG. 4 illustrates a side view of a further trailer including an ATM;

FIG. 5 illustrates a perspective view of an electric vehicle including a side-facing ATM;

FIG. 6 illustrates a perspective view of an electric vehicle including a rear-facing ATM;

FIG. 7 illustrates a perspective view of an electric vehicle including three side-facing ATMs;

FIG. 8 illustrates an electric vehicle including an ATM driving through a door;

FIG. 9 illustrates a first process for servicing an electric vehicle including an ATM;

FIG. 10 illustrates a second process for servicing an electric vehicle including an ATM;

FIG. 11 illustrates modularity of a vehicle, showing how an ATM can be removably installed within a vehicle body; and

FIG. 12 illustrates certain example ATM configurations for different environments.

In the drawings like reference numerals refer to like parts.

### DETAILED DESCRIPTION

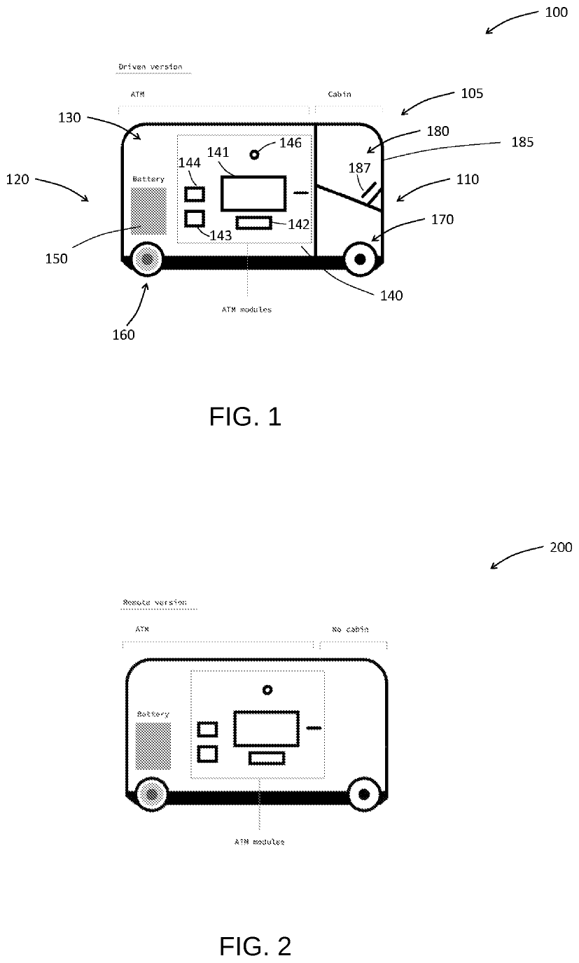

FIG. 1 illustrates an electric vehicle 100. The vehicle is suitable for transporting one or more ATMs from a first location to a second location. For example, the vehicle may transport the ATM from a central hub to an interior of a shopping mall. Other locations may be possible such as a university campus, a place of business, an event, an airport or the like. The vehicle 100 includes a vehicle body 105 which has a first end 110 which may be referred to as a front end. The front end is the end which in use faces a direction of travel. The vehicle body also has a further end 120 which may be referred to as a rear end. The rear end is the end which in use faces away from a direction of travel. It will be appreciated that the first end is opposite the further end. The vehicle body 105 also has a first side 130 (facing out from the page) and a second side (facing into the page), opposite the first side. It will be appreciated that in other embodiments only a single side may be provided. The vehicle body also has a roof (not shown) and a floor/base (not shown). An outer surface of the vehicle body is provided by all of the outer surface which is visible to a user. For example, the outer surface may include the outer surface of each of the first and second side and the outer surface at the front end and rear end of the vehicle body. The outer surface may also include an outer surface of the roof of the vehicle body.

The width of the vehicle body (i.e., the distance between the first side and the second side of the vehicle body) is less than 1 meter and is optionally between 0.8 and 0.95 meters and is optionally less than 0.914 meters. The height of the vehicle body (i.e., a distance between the floor and the roof of the vehicle body) is less than 2.5 meters, and is optionally between 2.0 and 2.1 meters and is optionally less than 2.032 meters. Alternatively, the total height of the vehicle (i.e., distance from ground to the roof of the vehicle body) may be less than 2.5 meters and optionally is between 2.0 and 2.1 meters and optionally is less than 2.032 meters. The height and width of the vehicle means that the vehicle is able to travel comfortably through normal sized doors (see FIG. 8) and it can be driven both indoors and outdoors. The vehicle can also be driven onto a delivery van by using a ramp.

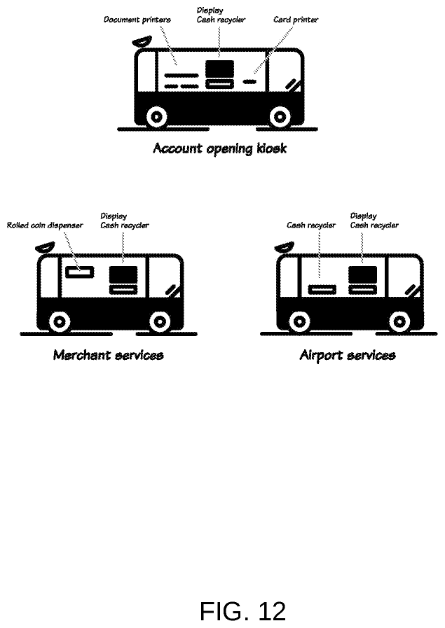

The vehicle body also includes an Automated Teller Machine (ATM) 140. The ATM is supported by the floor (now shown) of the vehicle body. Whilst only a single ATM is shown in FIG. 1, it will be appreciated that in other embodiments multiple ATMs may be included as part of the vehicle body. The ATM may be a module that is removable from the vehicle body. This is better illustrated in FIG. 11. The ATM includes one or more processors (not shown), at least one memory (now shown) and a display 141. The memory is a non-transitory computer-readable storage medium. The memory stores executable software that is executable by the processors of the ATM. The display 141 displays a graphical user interface for enabling the user to enter details and select options during transactions at the ATM. The ATM functionality is configurable to suit the context and environments in which its situated by including any combination of conventional ATM components in the ATM. Some example configurations for different environments are shown in FIG. 12. The ATM may include any combination of an encrypted PIN pad 142, a note dispenser 143, a receipt printer 144, a card slot 145 for insertion of a user's bank card, a contactless reader (not shown), a camera 146, a barcode reader (not shown), a cash recycler (not shown), a card printer (not shown), a touchscreen (not shown), a coin dispenser (now shown), a rolled coin dispenser (now shown), a microphone (not shown), speakers (not shown), mixed media deposit (now shown), biometric user authentication (now shown), cheque deposit module (not shown) or the like as will be appreciated by a person of skill in the art. The ATM may also include a communication interface (not shown) for communicating wirelessly with a central data hub. When the ATM is an ITM, the ATM may further include additional functionality. For example, the ITM may include a signature pad, an ID scanner, a telephonic handset, a wired headset, a tactile keyboard, a beamforming microphone or the like as will be appreciated by a person of skill in the art. This hardware may not be present on a conventional non-ITM ATM. The ITM may also have functionality to enable an audio and video communication link to be established with a remote teller device. This functionality may not be present on a conventional non-ITM ATM. The vehicle is weatherproof and as secure as a conventional through-the-wall ATM. Cash is stored inside a safe of the ATM. The electric vehicle may be referred to as a remote micro branch.

As can be seen in FIG. 1, the fascia 150 of the ATM forms part of the outer surface of the vehicle body. Particularly, the fascia forms part of the first side 130 of the vehicle body. It will be appreciated by the skilled person that the fascia of the ATM is the moulded front of the ATM that faces the customer in use. In other words, the fascia and outer shell of the ATM forms part of the bodywork of the vehicle. A minimum height of certain ATM components from the base/floor of the vehicle body is less than a certain distance. Alternatively, the minimum height of certain ATM components from the ground is below this certain distance. The minimum height is the lowermost point of the ATM component. Particularly, the minimum height of certain ATM components is no more than 1.2 meters from the base of the vehicle body or the ground. The certain ATM components may include the display and the encrypted PIN pad and the card reader and the cash dispenser, or any combination thereof. The ATM interface is thus low enough to be used by a person in a wheelchair and no step access is required.

It is noted that the depth of the ATM (i.e., the distance which the ATM extends between the first side and second side of the vehicle body) is approximately equal to the width of the vehicle body (i.e., the distance between the first side and second side of the vehicle body). The difference between the depth of the ATM and the width of the vehicle body is less than 0.5 meters and is optionally less than 0.1 meters. This means that the vehicle is as compact as possible.

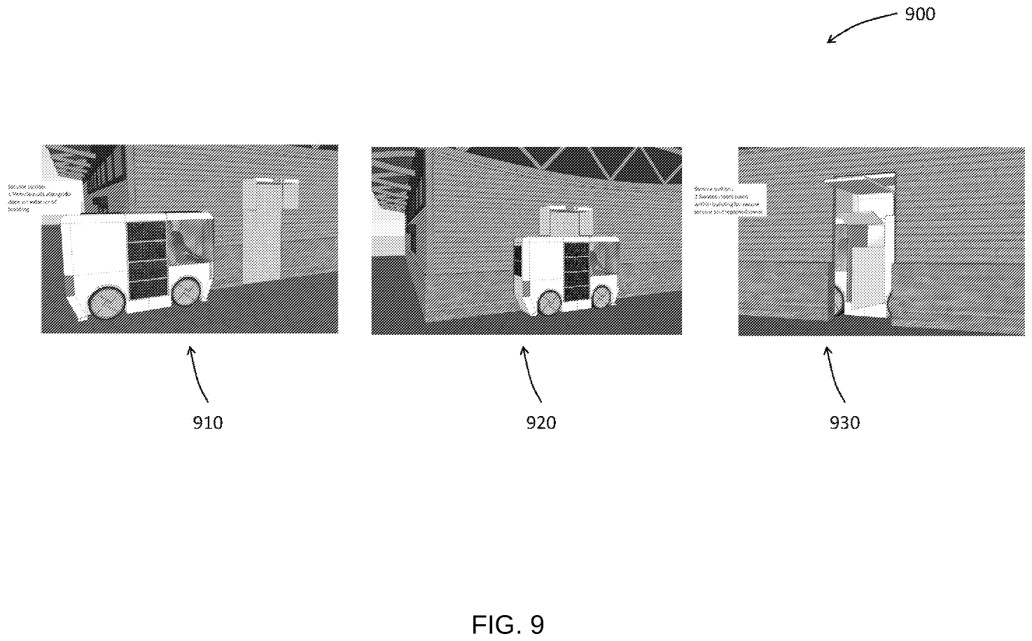

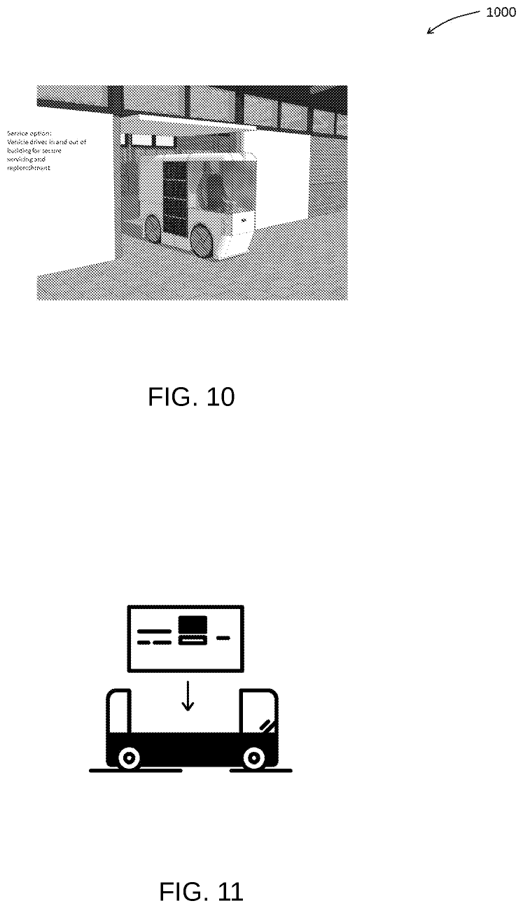

The ATM may be connected wirelessly to a central data facility or an ATM network. This enables video and audio banking services to be performed if the ATM is an ITM. That is, a user of the ATM has the ability to communicate with a remote teller. The ATM is also able to report status updates to the data facility wirelessly. For example, the ATM can report its' location, cash volume status, transaction rates, ATM health, battery status and the like. This may enable action to be taken if the ATM needs to be serviced such as directing the vehicle to a service location as described with respect to FIGS. 9 and 10.

The vehicle body also includes a battery 150. It will be appreciated that in other embodiments more than one battery may be provided. The battery provides power to the ATM 140. The battery also provides power to an electric motor (not shown) that provides a driving force to the rear set of wheels 160. The rear set of wheels are located beneath the rear end of the vehicle body. It will be appreciated that in other embodiments more than one electric motor may be provided. Each electric motor may provide a driving force to a single wheel or a set of wheels. It will also be appreciated that in other embodiments the front set of wheels 170 may also be driven by an electric motor. The front set of wheels may be located beneath the front end of the vehicle body. The electric motor(s) may be located at the wheel(s). Each of the wheels may be independently steerable (i.e., the vehicle has 4-wheel steering) to allow the vehicle to be driven into tight spaces.

In the embodiment of FIG. 1, the electric vehicle is internally drivable by a person. The vehicle body thus has at its' first end a driver cabin 180. The driven cabin includes a transparent windscreen 185 to enable a driver to see a direction of travel. The driver cabin also includes a steering wheel 187, an accelerator control (not shown) and a brake control (not shown). It will be appreciated that other standard EV driving components may be included in the cabin as will be appreciated by one of skill in the art.

The vehicle illustrated in FIG. 1 can be left unattended until battery or cash in the safe of the ATM is due to run out. The vehicle can be plugged in or run from the battery. Upon replacement or removal, the previously deployed unit can return to a service location for cash and battery replenishment and repairs. This is described in more detail below with respect to FIGS. 9 and 10.

FIG. 2 illustrates an alternative electric vehicle 200. The EV in FIG. 2 includes many of the same components as described with respect to FIG. 1. However, a difference of the EV in FIG. 2 is that it has no driver cabin. Thus, the front end need not include a transparent windscreen and no steering wheel is needed. The EV of FIG. 2 could be controlled by an operator located remotely from the vehicle or could be a self-driving vehicle.

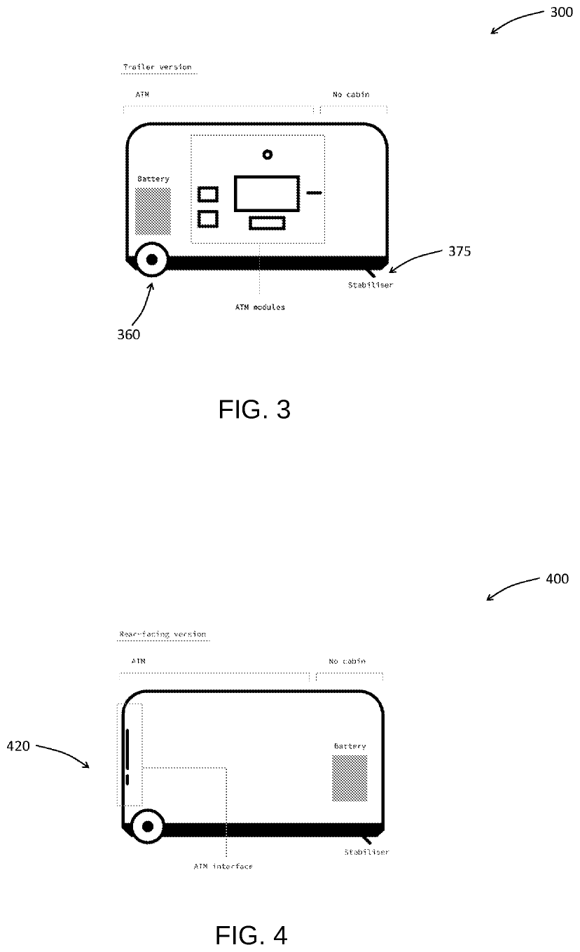

FIG. 3 illustrates a trailer 300. The trailer has a vehicle body similar to that described with respect to FIG. 2 (like in FIG. 1 but no driver cabin). However, in the trailer of FIG. 3, no electric motors are needed to provide a driving force to the rear wheels. Instead, the battery only provides power to the ATM within the trailer. Additionally, the trailer of FIG. 3 only has a rear set of wheels 360 supporting the rear end of the vehicle body and one or more stabilisers 375 supporting the front end of the vehicle body. It will be appreciated that in other embodiments a set of front wheels could be used in place of the stabilisers. The trailer of FIG. 3 may be towed by an electric vehicle (e.g., a standard EV or an EV like those illustrated in FIG. 1 or FIG. 2).

FIG. 4 illustrates a further trailer 400. This trailer is similar to the trailer described above with respect to FIG. 3. However, instead of having the fascia of the ATM forming part of the outer surface of the first side of the vehicle body, the fascia of the ATM in FIG. 4 forms part of the outer surface of the rear end 420 of the vehicle body. It will be appreciated that in other embodiments the ATM may form part of the outer surface of the front end of the vehicle body. It will also be appreciated that multiple ATMs may have respective fascias forming part of the outer surface at a combination of the front end, rear end and side of the vehicle body. It will be appreciated that the configuration in FIG. 4 (ATM at rear end) is readily applicable to the vehicles illustrated in FIGS. 1 to 3.

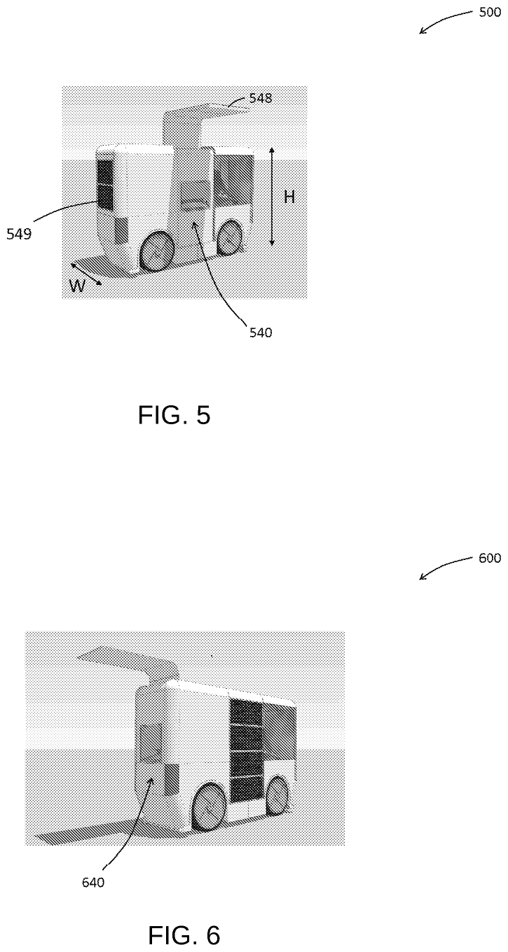

FIG. 5 illustrates a perspective view of an electric vehicle 500 with a side-facing ATM 540 (like in FIG. 1). The height H and width W of the electric vehicle are shown diagrammatically. FIG. 5 also shows how a door 548 can be connected to the vehicle body. The door is connected to the vehicle body via a hinge (not shown) located on the roof of the vehicle body. However, it will be appreciated that in other embodiments the hinge may be located on a side or on an end of the vehicle body (depending on where the door is located and which way it opens). It can be seen that the door is located in a position which enables a user to access the ATM. The door is able to pivot about the hinge into another position in which the door covers the ATM. It will be appreciated that a door may be provided for each ATM within the vehicle body. It will also be appreciated that in certain embodiments, no doors are present. FIG. 5 also illustrates how a solar panel 549 may be located on a rear end of the vehicle body. The solar panel is electrically connected to the battery and provides power to the battery (when exposed to sunlight) in order to at least partially re-charge the battery. Whilst the solar panel is on the rear end of the vehicle body in FIG. 5, it will be appreciated that in other embodiments a solar panel may additionally or alternatively be located on the roof, the front end (when there is no driver cabin), the first side or the second side of the vehicle body.

FIG. 6 illustrates a perspective view of an electric vehicle 600 with a rear-facing ATM 640. It will be seen that in FIG. 6 the solar panel is located on the side of the vehicle body and that there is a door for covering the ATM at the rear end.

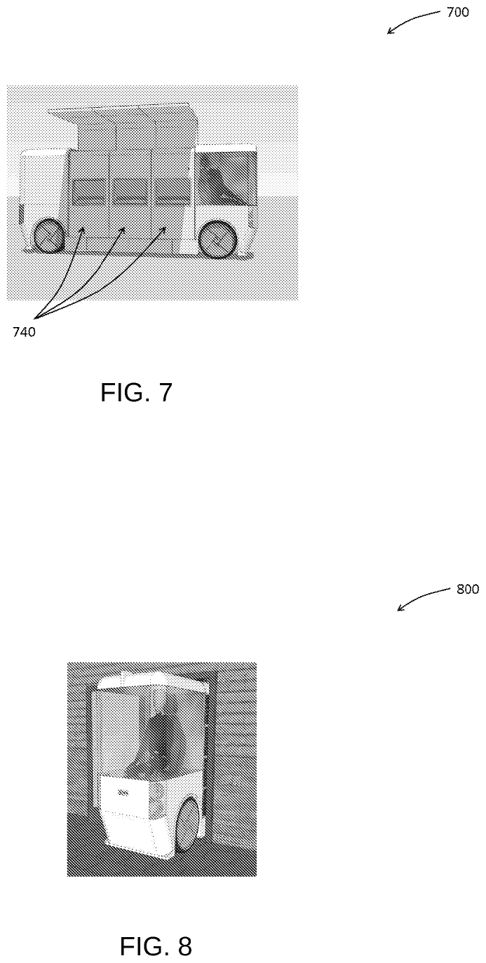

FIG. 7 illustrates an electric vehicle 700 including three side-facing ATMs showing how more than just one ATM can be incorporated into the vehicle body. It will be seen that a hingeable door is provided for each of the ATMs.

FIG. 8 helps to illustrate an electric vehicle 800 comprising an ATM as described herein travelling through a doorframe due to its' dimensionality as described hereinabove.

FIG. 9 helps illustrate a first process 900 for servicing an electric vehicle including an ATM. In a first step 910, the vehicle including the ATM drives to a position adjacent an opening in an outer wall of a building. The opening may for example by a door or custom made dock. In a second step 920, the vehicle stops at the opening in the building. In a third step 930, two access doors on the vehicle are opened in order to provide access to the ATM within the vehicle. The access doors are opened into the interior of the building (via the opening) such that a service engineer within the building can service the ATM. The service may include re-charging the battery of the vehicle, replenishing cash into the safe of the ATM, or performing a maintenance operation on the ATM. Whilst two access doors are shown in FIG. 9, it will be appreciated that any number of access doors (one or more) may be used. The building may be a service location for the vehicle. The service location may be referred to as a central hub. The hub may be a location that was previously a bank branch. Alternatively, the hub may be an existing bank branch adapted to be a hub. Performing a service at a central hub removes the need for CE's and CIT's to travel. By centrally locating parts, spares and replenishment there may be significant cost benefits and reduction in environmental impact.

FIG. 10 illustrates a second process 1000 for servicing an electric vehicle including an ATM. The process of FIG. 11 is generally similar to that of FIG. 10 with the exception that instead of driving the vehicle to a location adjacent an exterior of a building, the vehicle is driven into the building itself. The vehicle can then be stopped and the access doors opened at any convenient location within the building.

FIG. 11 illustrates how an electric vehicle can be provided with an ATM module with a specific configuration according to needs of a specific environment. The ATM module is removably coupled to the vehicle body allowing replacement with other ATM modules. FIG. 12 shows three examples of different ATM configurations for different environments.

Throughout the description and claims of this specification, the words “comprise” and “contain” and variations of them mean “including but not limited to” and they are not intended to (and do not) exclude other moieties, additives, components, integers or steps. Throughout the description and claims of this specification, the singular encompasses the plural unless the context otherwise requires. In particular, where the indefinite article is used, the specification is to be understood as contemplating plurality as well as singularity, unless the context requires otherwise.

Although the present disclosure has been particularly shown and described with reference to
the preferred embodiments and various aspects thereof, it will be appreciated by those of
ordinary skill in the art that various changes and modifications may be made without departing
from the spirit and scope of the disclosure. It is intended that the appended claims be interpreted as including the embodiments described herein, the alternatives mentioned above,
and all equivalents thereto.

Features, integers, characteristics or groups described in conjunction with a particular aspect, embodiment or example of the invention are to be understood to be applicable to any other aspect, embodiment or example described herein unless incompatible therewith. All of the features disclosed in this specification (including any accompanying claims, abstract and drawings), and/or all of the steps of any method or process so disclosed, may be combined in any combination, except combinations where at least some of the features and/or steps are mutually exclusive. The invention is not restricted to any details of any foregoing embodiments. The invention extends to any novel one, or novel combination, of the features disclosed in this specification (including any accompanying claims, abstract and drawings), or to any novel one, or any novel combination, of the steps of any method or process so disclosed.

What is claimed is:

1. A vehicle for transporting at least one Automated Teller Machine (ATM) from a first location to a second location, the vehicle comprising:
a vehicle body comprising a first end, a further end, opposite the first end, and at least one side extending between the first end and the further end, wherein the vehicle body comprises:
at least one ATM, wherein at least one respective fascia of the at least one ATM forms part of an outer surface of the vehicle body; and
at least one battery configured to provide power at least to the at least one ATM.

2. The vehicle as claimed in claim 1, wherein a difference between a depth and/or a width of the or each ATM and a width of the vehicle body is no more than 0.5 meters.

3. The vehicle as claimed in claim 2, wherein the width of the vehicle body is less than 1 meter.

4. The vehicle as claimed in claim 1, wherein a height of the vehicle body is less than 2.5 meters.

5. The vehicle as claimed in claim 1, wherein a minimum height of a display and/or an encrypted PIN pad and/or a card reader and/or a cash dispenser of the ATM is no more than 1.2 meters from a base of the vehicle body.

6. The vehicle as claimed in claim 1, wherein the fascia of at least one said ATM forms part of the outer surface on the side of the vehicle body.

7. The vehicle as claimed in claim 1, wherein the fascia of at least one said ATM forms part of the outer surface on the further end of the vehicle body.

8. The vehicle as claimed in claim 1, further comprising:
at least one door, hingeably connected to the vehicle body, locatable in a first position and a second position; and
wherein in the first position, the door covers the ATM and wherein in the second position, the door exposes the ATM to enable a user to access the ATM.

9. The vehicle as claimed in claim 1, further comprising:
at least one solar panel, on a roof and/or the side and/or the first end and/or the further end of the vehicle body, electrically connected to the battery for proving power to the battery.

10. The vehicle as claimed in claim 1, wherein a floor of the vehicle body supports the ATM.

11. An electric vehicle for transporting at least one Automated Teller Machine (ATM) from a first location to a second location, the electric vehicle comprising:
a vehicle body comprising a first end, a further end, opposite the first end, and at least one side extending between the first end and the further end, wherein the vehicle body comprises:
at least one ATM, wherein at least one respective fascia of the at least one ATM forms part of an outer surface of the vehicle body; and
at least one battery configured to provide power at least to the at least one ATM.

12. The electric vehicle as claimed in claim 11, the electric vehicle further comprising:
a plurality of wheels, supporting the vehicle body, for moving the vehicle body across a surface; and
at least one electric motor for providing a driving force to the wheels, wherein said battery provides power to the electric motor.

13. The electric vehicle as claimed in claim 12, further comprising:
a driver cabin, at the first end of the vehicle body, comprising a steering wheel, an accelerator control and a brake control.

14. The electric vehicle as claimed in claim 13, wherein the first end of the vehicle body comprises a transparent windscreen.

15. The electric vehicle as claimed in claim 14, wherein the plurality of wheels comprises a first set of wheels, arranged beneath the first end of the vehicle body and a second set of wheels, arranged beneath the further end of the vehicle body.

16. The electric vehicle as claimed in claim 15, wherein each of the plurality of wheels is independently steerable.

17. The electric vehicle as claimed in claim 11, wherein the vehicle is a trailer connected or connectable to the electric vehicle.

18. The electric vehicle as claimed in claim 17, the trailer further comprising:
a plurality of wheels, supporting the vehicle body at the first end, for moving the vehicle body across a surface; and
at least one stabiliser, supporting the vehicle body at the further end.

19. A method for servicing an Automated Teller Machine (ATM), comprising the steps of:
driving a vehicle comprising at least one ATM, wherein at least one respective fascia of the at least one ATM forms part of an outer surface of a body of the vehicle, into a building or to a position adjacent an opening in an outer wall of the building;
opening an access door on the vehicle, that allows an operator to access a rear portion of the ATM, into an interior of the building; and
servicing the ATM.
